(19) United States
(12) Patent Application Publication
(10) Pub. No.: US 2005/0244689 A1
(43) Pub. Date: Nov. 3, 2005

(54) Separator and fuel cell system using that separator

(76) Inventors: Munehisa Horiguchi, Aichi-ken (JP); Masao Ando, Aichi-ken (JP)

Correspondence Address: LARUSSO, LOUD & KELLY, 3137 Mount Vernon Avenue, Alexandria, VA, 22305, US

(21) Appl. No.: 11/108,061

(22) Filed: Apr. 18, 2005

(30) Foreign Application Priority Data
Apr. 28, 2004 (JP) 2004-133148

(51) Int. Cl. H01M 8/04

(52) U.S. Cl. 429/26; 429/34

(57) ABSTRACT

A separator of a fuel cell system, which is inserted between single cells, each single cell having an electrolyte sandwiched between electrodes, in order to form a cooling space between the single cells, includes a porous radiator plate that abuts against the electrodes of the single cells. As a result, the contact surface of the supplied air and the radiator plate increases due to the formation of the holes, which improves the function as radiation fins of transferring heat from the electrodes to the air flowing through the cooling space.

### BACKGROUND OF THE INVENTION

1. Field of the Invention

The present invention relates to a fuel cell, and more particularly, to a cooling technology for a fuel cell that uses a separator interposed between single cells of the fuel cell.

2. Description of the Related Art

Various types of fuel cells exist, one of which is a polymer electrolyte fuel cell that is particularly well suited for mounting in vehicles due to its small size which is made possible by a low reaction temperature. This type of fuel cell is a stacked structure in which single cells (single fuel cells) consisting of membrane electrode assemblies (MEAs), each MEA having a polymer electrolyte membrane sandwiched between two gas diffusion electrodes (each of which includes a catalyst layer and a porous support layer (i.e., a gas diffusion layer)), are stacked with a separator that forms a supply channel for reaction gases such as hydrogen (i.e., a fuel gas) and oxygen (i.e., an oxidizing gas) arranged on the outside of each MEA. The separator both acts as an impermeable barrier that prevents the reaction gases from permeating MEAs that are adjacent in the stacking direction, and collects power in order to draw the generated electric current to the outside. The MEA and separator together are stacked in multiple layers to form a cell stack.

The electrolytic reaction in fuel cells generates heat of a heat quantity that substantially corresponds to the power generated, so a cooling mechanism must be provided to prevent the single cells from heating up excessively, particularly in polymer electrolyte fuel cells which operate at a low temperature. For this kind of cooling mechanism, a cooling passage is typically provided separately from a reaction gas supply passage in the cell stack, and cooling water is run through this passage, for example.

In order to cool the electrolyte membrane in this way, the applicant has proposed technology which directly air cools the single cells by increasing the supply of air, which serves as the oxidizing gas supplied to the air electrode, to a far greater amount than is originally necessary for the reaction. Furthermore, in order to keep the electrolyte membrane moist, a system is employed which mixes humidifying water in the form of mist with air supplied to the air electrode, and then supplies this mixture to the gas diffusion electrode. More specifically, in attempt to improve manufacturability of the separator and make the fuel cell thinner, this technology employs a structure in which a spacer portion of the separator is a corrugated (i.e., wavy) thin metal plate with air holes provided in a portion midway between the mountain peaks and the mountain bases in the corrugated plate. The air and the humidifying water which has been vaporized by heat from the separator are then supplied to the gas diffusion electrodes through these air holes.

With this structure, the wavy shape of the spacer portions of the separator enables both the gas supply passage to be divided up so that the reaction gas can be evenly supplied to the electrodes. Furthermore, the cooling efficiency, combined with cooling by air flow, can be improved by using the vaporization of the humidifying water within the gas supply passages for latent heat cooling as well.

Japanese Patent Laid-Open Publication No. 5-29009 proposes a molten carbonate fuel cell, in which the electrodes do not need to be kept moist, where the separator is formed of a thin metal plate. In this related art, the portion (i.e., the collector) that abuts against the electrodes is a flat metal plate with holes in it, and the portion that forms the gas supply passage (i.e., a flow path plate which serves as a spacer) is a wavy shaped metal plate with holes in it that has been press formed.

Japanese Patent Laid-pen Publication No. 6-44981 also discloses art of a similar structure. In this technology, units of a solid electrolyte plate with an electrode integrally formed on each side are stacked together via a porous conductive flat plate, a porous corrugated plate which serves as a conductive spacer, and a separator provided with flat-bottomed depressed portions or the like on both sides.

The technologies disclosed in Japanese Patent Laid-Open Publication No. Hei 5-29009 and Japanese Patent Laid-pen Publication No. Hei 6-44981 relate to fused carbonate fuel cells, and require that carbon dioxide be supplied simultaneously with air to the oxidation electrode side. Therefore, these technologies are not intended to cool single cells by supplying air at normal pressure, as is proposed by the applicant.

Further, these technologies employ structures in which a flow path plate or a conductive spacer contacts the electrode via a collector or a conductive flat plate. As a result, the contact surface between the electrode surface and the air flow becomes narrow due to the holes being offset at the portion where the flow path plate or the conductive spacer and the collector or the conductive flat plate overlap. Therefore, even if these structures were to be used for air cooling, a sufficient cooling effect could not be expected.

### SUMMARY OF THE INVENTION

In view of the foregoing problems, the main object of the present invention is to improve cooling efficiency with a simple structure in a fuel cell in which single cells are cooled using air supplied to the air electrode side.

In order to achieve this object, the present invention provides a separator of a fuel cell system, which is inserted between single cells, each single cell having an electrolyte sandwiched between electrodes, in order to form a cooling space between the single cells. The separator is characterised in that it includes a porous radiator plate that abuts against one of the electrodes of one of the single cells.

Next, the present invention provides a fuel cell system in which a separator is interposed between fuel cells, each fuel cell having an electrolyte sandwiched between electrodes, in order to form a cooling space through which air flows at normal pressure between the single cells. The fuel cell system is characterised in that the separator includes a porous radiator plate that abuts against one of the electrodes of one of the single cells.

In the foregoing structure, the radiator plate preferably includes a heat transfer portion that contacts the electrode and a heat radiation portion which extends out into a space from the heat transfer portion, the heat transfer portion and the heat radiation portion being integrally provided.

Also, the heat radiation portion is preferably such that the cooling space is divided into multiple spaces which extend from one end of the cooling space to the other end of the cooling space.

Further, it is effective to have the radiator plate be formed of a wire mesh member having the shape of a wavy plate with rectangular waves, with the wave bottom portions of the rectangular waves serving as the heat transfer portion that contacts the electrode.

In this case, the aperture ratio of the wire mesh member is preferably at least 25%.

Also, the hole diameter of the wire mesh member is preferably 1 mm at most.

It is effective to apply any of the above structures to a structure in which the electrolyte of each single cell contains water.

According to the present invention, the radiator plate that contacts the electrodes of the single cell is porous so the supply of air to the electrodes is no longer restricted by the overlapping of the hole portions. Further, the contact surface of the radiator plate and the supplied air increases due to the formation of the holes, which improves the function as radiation fins of transferring heat from the electrodes to the air flowing through the cooling spaces. Therefore, both the diffusivity of air and the cooling efficiency can be improved by a simple structure in a fuel cell in which the single cells are cooled using air supplied to the air electrode side.

Also, when the radiator plate includes a heat transfer portion that contacts the electrode and a heat radiation portion that extends out from the heat transfer portion into the space provided integrally, the contact surface between the radiator plate and the supplied air is increased even more. Moreover, the heat transfer from the electrode to the heat radiation portion of the radiator plate improves.

Also, when the heat radiation portion is such that the cooling space is divided into multiple spaces that extend from one end of the cooling space to the other end of the cooling space, it is possible to eliminate an imbalance in the flow of air flowing through the cooling spaces using the heat radiation portion. As a result, the air can be diffused evenly, making it possible to both improve the diffusivity of air supplied to the electrode and average out the temperature distribution by even cooling of the electrode.

Furthermore, when the radiator plate is formed of a wire mesh member that is shaped like a rectangular wave-shaped plate, the contact portion of the electrode and the radiator plate becomes the flat mesh of the bottom portions of the rectangular waves. As a result, a contact state is established in which the contact pressure is high due to the contact of the mesh portion at the surface portions corresponding to the wave bottom width of the rectangular waves, such that power collection capacity by the radiator plate is improved. Furthermore, the diffusivity of the air supplied to the electrode also improves due to the wide open portions between the mesh.

### BRIEF DESCRIPTION OF THE DRAWINGS

FIG. 1 is a system block diagram of a fuel cell system;

FIG. 2 is a block diagram of a control system of the fuel cell system;

FIG. 3 is a flowchart of a start-up control of the fuel cell system;

FIG. 4 is a flowchart of an air supply control of the fuel cell system;

FIG. 5 is a top view of a cell module which forms a fuel cell stack according to a first exemplary embodiment of the present invention;

FIG. 6 is an elevation view of the cell module as viewed from the air electrode side;

FIG. 7 is an elevation view of the cell module as viewed from a fuel electrode side;

FIG. 8 is a top view of part of a horizontal cross-section taken along line B-B in FIG. 6;

FIG. 9 is a side view of part of a vertical cross-section taken along line A-A in FIG. 6;

FIG. 10 is a partial exploded perspective view of a separator of the cell module;

FIG. 11 is a partial exploded perspective view of a separator according to a second exemplary embodiment of the present invention; and

FIG. 12 is a partial exploded perspective view of a separator according to a third exemplary embodiment of the present invention.

FIG. 13 is a partial exploded perspective view of a separator according to a fourth exemplary embodiment of the present invention.

### DETAILED DESCRIPTION OF THE PREFERRED EMBODIMENTS

The present invention is particularly effective when applied to a fuel cell in which cooling water is added to the supplied air through direct injection and that mixture is then supplied to the air electrode side. As a result, in addition to cooling by the air flow, the cooling water evenly adheres to, and is retained on, the porous radiator plate, thereby making even latent heat cooling possible over the entire electrode surface using the heat generated from the reaction, thus further improving cooling performance.

The aperture ratio of the wire mesh member is preferably large in view of supplying a sufficient amount of reaction gas to the electrodes, and preferably at least 25% to be functional.

Further, the hole diameter of the wire mesh member is preferably 1 mm at most in view of making the reaction gas diffusion even.

### First Embodiment

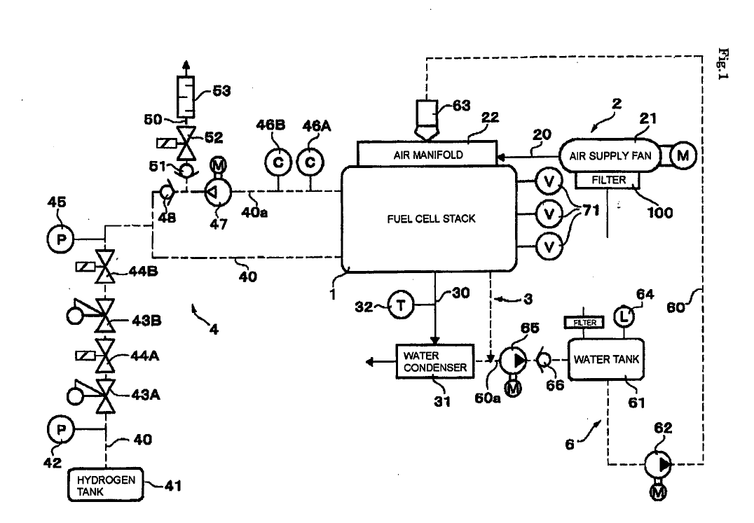

Hereinafter, exemplary embodiments of the present invention will be described with reference to the appended drawings. First, FIGS. 1 to 10 illustrate a first exemplary embodiment of the present invention. FIG. 1 is an example of a diagram of a vehicular fuel cell system which uses a fuel cell stack 1 according to one application of the present invention. The fuel cell stack 1 serves as the main component of the fuel cell system which also includes a fuel cell main portion, a fuel supply system 4, and a water supply system 6. The fuel cell main portion includes i) an air supply system (indicated by the solid lines in the drawing) 2 including an air fan 21 which serves as an air supply mechanism that supplies air to the fuel cell stack 1, and ii) an air exhaust system 3 including a water condenser 31. The fuel supply system 4 (indicated by the alternate long and two short dashes line in the drawing) includes a hydrogen tank 41 which serves as a hydrogen supply mechanism. The water supply system 6 (indicated by the broken line in the drawing) serves to moisten and cool the reaction portion.

The air fan 21 disposed in the main portion of the fuel cell is connected to an air manifold 22 via an air supply line 20. The air manifold 22 is in turn connected to a case, not shown, which houses the fuel cell stack. The water condenser 31 is interposed in an air discharge line 30 of the case and connected to the fuel cell stack 1. An exhaust temperature sensor 32 is arranged in the air discharge line 30.

The fuel supply system 4 is provided in order to deliver hydrogen stored in the hydrogen tank 41 to hydrogen passages in the fuel cell stack 1 via the hydrogen supply line 40. Provided in the hydrogen supply line 40 are, in order from the hydrogen tank 41 side to the fuel cell stack 1 side, a primary pressure sensor 42, a pressure regulating valve 43A, a supply electromagnetic valve 44A, a pressure regulating valve 43B, a supply electromagnetic valve 44B, and a secondary pressure sensor 45. Incidentally, a hydrogen return line 40a and a hydrogen discharge line 50 are also provided in the hydrogen supply line 40. Arranged in the hydrogen return line 40a, in order from the fuel cell stack 1 side, are hydrogen concentration sensors 46A and 46B, a suction pump 47, and a check valve 48. A portion of the hydrogen return line 40a that is downstream of the check valve 48 is connected to the hydrogen supply line 40. The hydrogen discharge line 50 is connected to the hydrogen return line 40a between the suction pump 47 and the check valve 48. A check valve 51, a discharge electromagnetic valve 52, and a combustor 53 are provided in the hydrogen discharge line 50.

The water supply system 6 is provided in order to deliver water stored in a water tank 61 to multiple nozzles 63 disposed in the air manifold 22 of the fuel cell stack 1 via a water supply line 60. A pump 62 is arranged in the water supply line 60. Also, a level sensor 64 is disposed in the water tank 61. The water supply system 6 also has a water return line 60a that connects the fuel cell stack 1 to the water tank 61. A pump 65 and a check valve 66 are arranged in the water return line 60a. The water return line 60a is connected to the water condenser 31 at the upstream side of the pump 65. Voltage meters 71 in the drawing monitor the back electromotive voltage of the fuel cell.

FIG. 2 is a block view of a control system of the fuel cell system shown in FIG. 1. The blocks shown in the left hand column in FIG. 2 indicate input mechanisms for obtaining information for control while the blocks shown in the right hand column indicate output mechanisms that are the objects to be controlled. A control apparatus 8, which is a computer connected to these mechanisms, is provided with memory 81 and is housed in a control box (not shown in FIG. 1) of the fuel cell system. Control programs which specify the operations of the control apparatus 8, as well as parameters and lookup tables that are used when executing the various controls are stored in the memory 81.

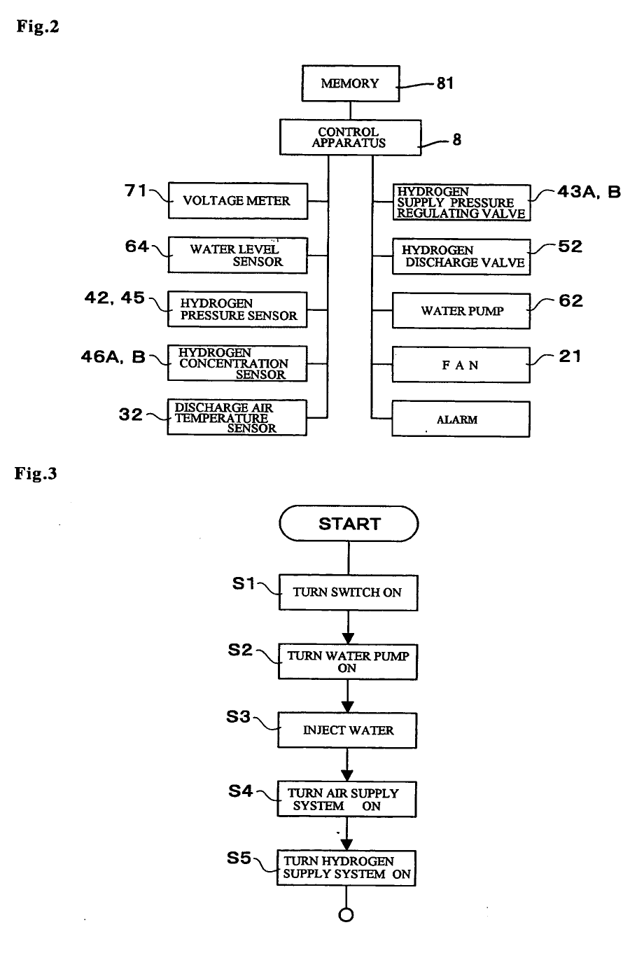

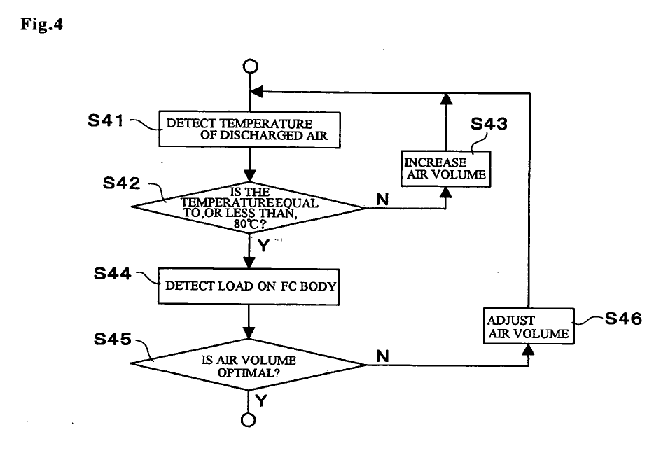

Next, operation control of the fuel cell system according to this exemplary embodiment will be described. This operation control includes hydrogen supply amount control, air supply amount control, and water supply amount control. First, referring to the flow illustrated in FIG. 3, after a startup switch (not shown in FIGS. 1 and 2) is turned on in step S1 at startup of the fuel cell system, the water pump 62 is then turned on in step S2. At this time, the operating state of the water pump 62 is adjusted so that a predetermined amount of water is injected from the nozzles 63 into the air manifold 22 in step S3. The amount of water at this time is an amount whereby the maximum amount of water is supplied to the air electrode in order to protect the fuel cell stack 1 from an abnormal reaction. Next, the air supply system 2 is turned on in step S4. The air volume of the air fan 21 at this time is also set to the maximum to cool the single cells so as to prevent an abnormal reaction. The hydrogen supply system 4 is then turned on in step S5. Once the desired output between the air electrode and the fuel electrode of the fuel cell stack 1 has been confirmed in this way, power is then output to an external load.

In the foregoing flow, the air supply system 2 (i.e., step S4) may be operated before operation of the water supply system 6 (i.e., step S3) or after operation of the hydrogen supply system 4 (i.e., step S5), but the water supply system 6 must be operated before the hydrogen supply system 4 is operated. This is because since air exists in the single cell regardless of whether the air supply system 2 is operating or not, abnormal combustion may occur if hydrogen is supplied when the electrolyte membrane is dry. That is, even if anomalous heat is generated from this combustion, water is injected to wet the air electrode prior to hydrogen being supplied so as that the single cell does not suffer damage. As a result, anomalous heat is converted into water evaporation heat, thus further promoting the moistening of the electrolyte membrane, and thereby preventing the single cells from becoming damaged.

After startup is complete, as described above, the hydrogen supply amount control, the air supply amount control, and the water supply amount control are all executed in parallel. In the hydrogen supply amount control, the pressure regulating valves 43A and 43B are adjusted so that hydrogen gas is supplied to the fuel electrode at a predetermined concentration equal to, or less than, an explosion limit. The discharge electromagnetic valve 52, which is closed at startup, is opened based on a preset rule, gas with a lowered hydrogen partial pressure is discharged, and the ambient gas of the fuel electrode is refreshed. The preset rule at this time is stored in the memory 81. The adjusting of the pressure regulating valves 43A and 43B and the opening and closing of the discharge electromagnetic valve 52 are executed by the control apparatus 8 reading this rule from the memory 81. The reason that the discharge electromagnetic valve 52 is appropriately opened during operation in this way is because if the fuel cell system continues to operate while the discharge electromagnetic valve 52 is closed, the effect of N₂, O₂, or water that was produced permeating from the air electrode would result in a gradual decrease in the partial pressure of the hydrogen consumed by the fuel electrode. As a result, the output voltage would also drop so a stable voltage would not be able to be obtained.

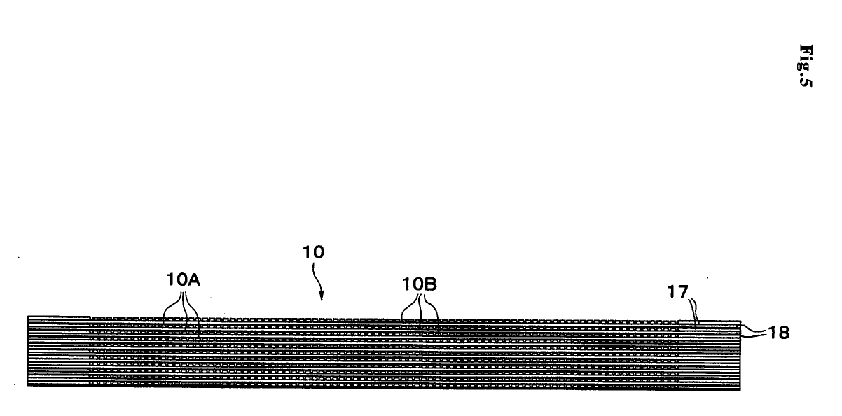

Next, in the air supply amount control, referring to the flow in FIG. 4, in step S41, the discharge air temperature sensor 32 detects the temperature of the discharged air immediately after it has been discharged from the fuel cell stack 1. If it is determined in step S42 that the temperature is above 80° C., the single cells may burn out, so the speed of the air fan 21 is increased in step S43 to increase the air volume and reduce the temperature of the air electrode which is the heat generating source. At this time, water of an amount necessary to cool those single cells which are over 80° C. is supplied to the cooling gas flow path between single cells. If, on the other hand, it is determined in step S42 that the detected temperature is equal to, or less than, 80° C., the load on the single cells is then detected in step S44. Then in step S45 it is determined whether the air volume is optimal by checking the relationship between the fuel cell load and the air volume necessary for that load against the relationship stored in table form in the memory 81. If it is determined at that time that the air volume is not optimal, the air volume is adjusted in step S46.

Next, in the water supply amount control, water is pumped from the water tank 61 by the water pump 62 and sprayed from the nozzles 63. The delivery pressure of the spray is adjusted by adjusting the voltage supplied to the water pump 62 so as to obtain the desired amount of water. The amount of water supplied in this case is set in advance according to the discharge air temperature. This amount is made the smallest amount necessary to maintain the discharge air temperature in order to minimize the power loss from the water pump 62. The supply of water can also be stopped if the discharge air temperature is equal to, or less than, a predetermined temperature (such as 30° C.). The relationship between the discharge air temperature and the amount of water that should be supplied at that time, and furthermore, the amount of water and the pump delivery pressure, is calculated with reference to the lookup table stored in the memory 81.

There are also other methods for controlling the water supply amount. For example, the water supply system 6 may be operated at a fixed water pressure every time a predetermined period of time (e.g., 5 to 10 seconds) passes. Also, the water injection amount can be maintained constant and the amount of water supplied can be controlled by turning the water supply system 6 on and off according to the discharge air temperature and other operating conditions. Furthermore, even if more water is supplied than is necessary for cooling the stack from latent heat, the cooling performance of the stack will not decrease, so the maximum water supply amount corresponding to the maximum air volume (i.e., the maximum amount of air supplied) can always be supplied when the water pump 62 is on. Also, if the discharge air temperature is equal to, or less than, a predetermined temperature (such as 30° C.), the minimum amount of water can also be intermittently injected so as to minimize the load on the water supply system 6.

In the foregoing controls, in the fuel supply system 4, the hydrogen pressure on the hydrogen tank 41 side is monitored by the hydrogen primary pressure sensor 42 and adjusted to a pressure that is suitable for supply to the fuel cell stack 1 by the hydrogen pressure regulating valves 43A and 43B. The supply of hydrogen to the fuel cell stack 1 is then controlled by opening and closing the supply electromagnetic valves 44A and 44B. Closing the supply electromagnetic valves 44A and 44B interrupts the supply of the hydrogen gas. Also, the hydrogen gas pressure immediately before the hydrogen gas is supplied to the fuel cell stack 1 is monitored by the hydrogen secondary pressure sensor 45.

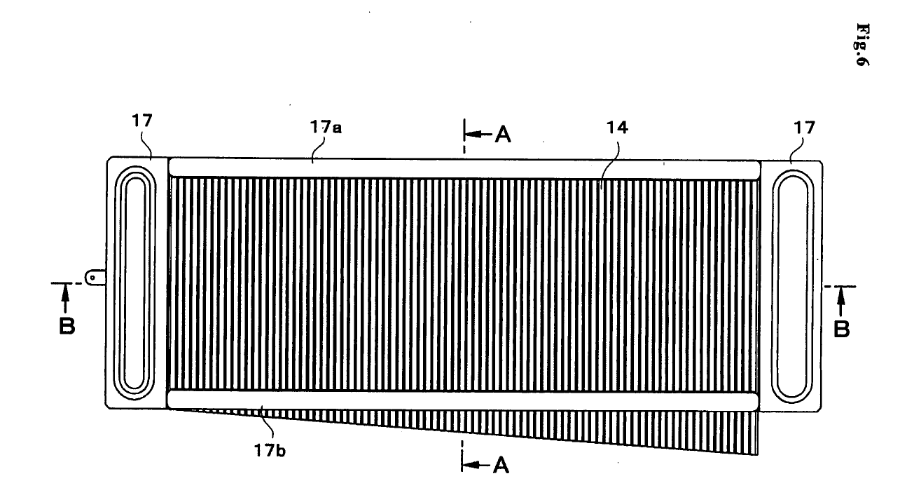

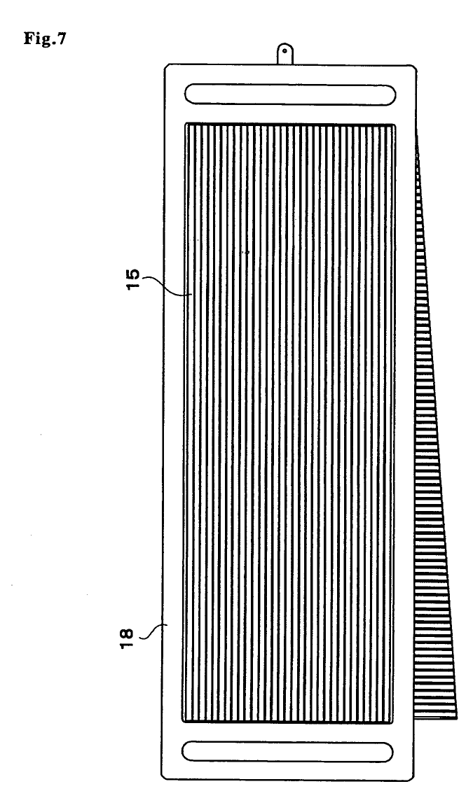

FIGS. 5 to 10 show the structure of the cell module 10 which is the unit from which the fuel cell stack 1 in the fuel cell system of the foregoing structure is formed. As shown by the top surface in FIG. 5 (hereinafter, the top/bottom and vertical/horizontal relationships in view of the position in which the cell module is arranged will be described), the cell module 10 is formed of a plurality of sets (the example in the drawing shows 10 sets) stacked together in the direction of thickness, each set including a single cell (MEA) 10A, a separator 10B which electrically connects pairs of single cells together and separates the flow passage of air from the flow passage of the hydrogen gas introduced into the single cells, and two kinds of frames 17 and 18 that support the single cell 10A and the separator 10B. The single cell 10A is positioned inside of the frame 18 so it is not clearly visible in FIG. 5. The cell module 10 is such that the single cells 10A and the separators 10B are stacked in multiple levels, with the two kinds of frames 17 and 18 stacked alternately as spacers, such that the single cells 10A are arranged a predetermined distance away from each other. One end, in direction of stacking, of the cell module 10, (i.e., the upper end side in FIG. 5) ends with the surface of the separator 10B that has protrusions formed in the vertical direction and the end surface of one frame 17, as shown in FIG. 6. The other end (the lower end side in FIG. 5) of the cell module 10 ends with the surface of the separator 10B that has protrusions formed in the horizontal direction and the end surface of the other frame 18, as shown in FIG. 7.

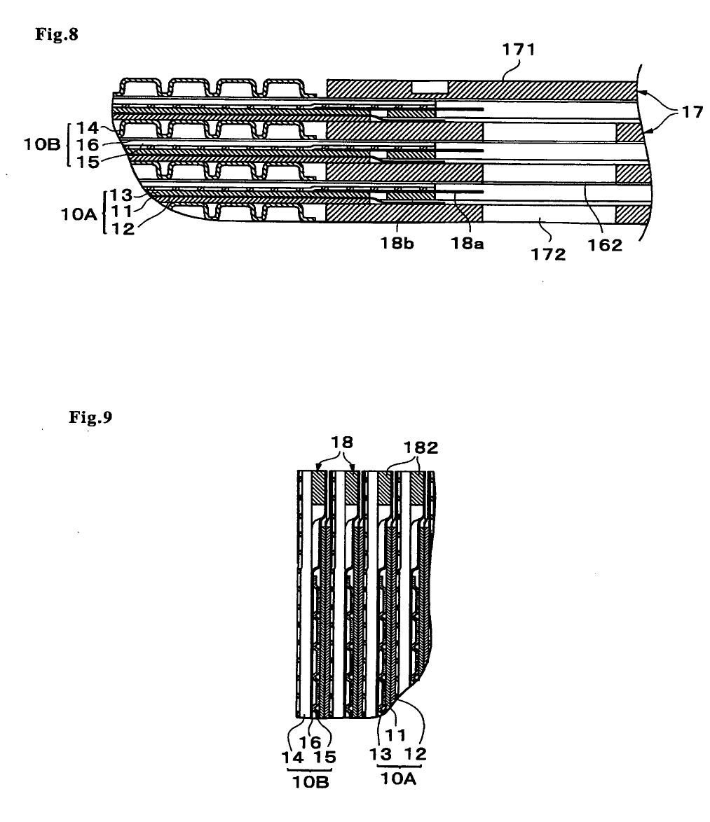

As shown in the exploded sectional diagrams of FIGS. 8 and 9, the single cell 10A includes a polymer electrolyte membrane 11, an air electrode 12 which is an oxidant electrode provided on one side of the polymer electrolyte membrane 11, and a fuel electrode 13 provided on the other side of the polymer electrolyte membrane 11. The air electrode 12 and the fuel electrode 13 are formed of a gas diffusion layer of conductive material such as carbon cloth through which the reaction gas permeates while diffusing, as described above, and a catalyst layer including catalyst material sandwiched between this diffusion layer and the polymer electrolyte membrane 11. Of these members, the air electrode 12 and the fuel electrode 13 have horizontal dimensions that are slightly longer than the width of an open portion of the frame 18 which serves as a support member for the air electrode 12 and the fuel electrode 13, and vertical dimensions that are slightly shorter than the height of that open portion. Further, the polymer electrolyte membrane 11 has vertical and horizontal dimensions which are one size larger than the vertical and horizontal dimensions of the open portion.

The separator 10B includes a separator substrate 16, a collector (hereinafter, referred to as “air electrode side collector”) 14, and a conductor (hereinafter, referred to as “fuel electrode side collector”) 15. The separator substrate 16 serves as a gas interruption member between single cells 10A. The air electrode side collector 14 is provided on one side of the separator substrate 16 and is formed of a mesh member in which multiple air holes are formed through which pass a mixture of air and water, and which contacts the gas diffusion layer on the air electrode side of the single cell 10A and collects power. The fuel electrode side collector 15 is provided on the other side of the separator substrate 16 and is in contact with the gas diffusion layer on the fuel electrode side of the single cell 10A. The fuel electrode side collector 15 is also formed of a mesh member for leading voltage to the outside.

In order to maintain a predetermined positional relationship of the separator substrate 16, the air electrode,side collector 14, and the fuel electrode side collector 15, as well as the single cell 10A, the frame 17 is arranged on both the left and right sides of the air electrode side collector 14 (i.e., the frame 17 forms a frame (see FIG. 6) in which the top and bottom ends of the frame are interconnected by backup plates 17a and 17b on the outermost side only), and the frame 18 is provided on the peripheral edge portions of the fuel electrode side collector 15 and the single cell 10A.

In this example, the collectors 14 and 15 formed of mesh members that form the gas diffusion portions and the spacer portions in the present invention are made of thin metal plates of expanded metal which has a thickness on the order of 0.2 mm, for example. Also, the separator substrate 16 is formed of an even thinner thin metal plate. The metal may be, for example, a metal that is conductive and anticorrosive, such as stainless steel, a nickel alloy, a titanium alloy, or one of those metals that has been, for example, gold plated or otherwise treated for anticorrosion and conductibility. The frames 17 and 18 are made of suitable insulating material.

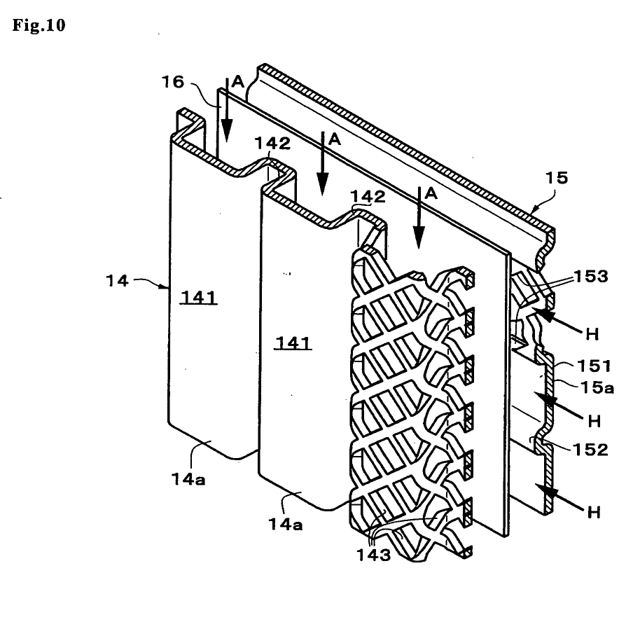

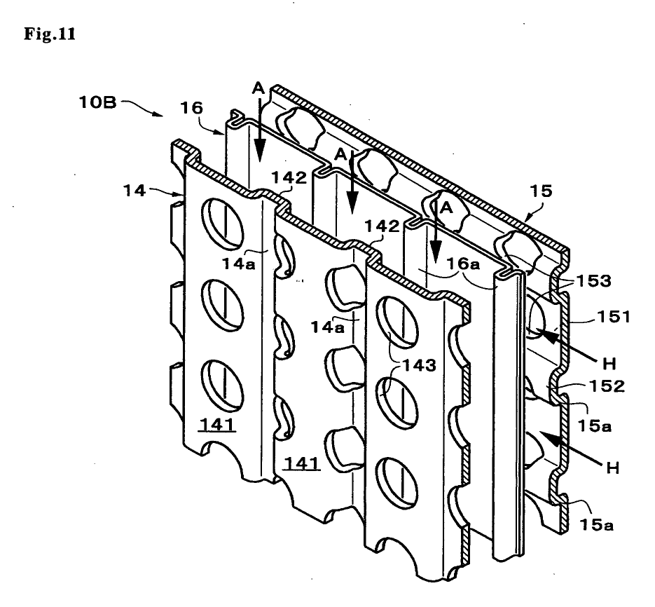

The overall shape of the air electrode side collector 14 is rectangular and horizontally long (the bottom side, however, is slanted in order to improve the draining effect). As shown in detail in the enlarged portion in FIG. 10, the air electrode side collector 14 is a wavy plate made from a mesh plate member (in the drawing, only a portion is shown as mesh in order to make it easier to see the shape of the plate surface) which has diamond-shaped air holes 143 with an aperture ratio of 59% and small protrusions 14a that have been formed by press working.

These protrusions 14a are arranged so that they travel the entire vertical length of the plate surface and are equidistant and parallel to the vertical sides (i.e., the short sides in the example shown in the drawing) of the plate member. As a result, gas flow paths are formed behind the protrusions which enable the flow rate at each portion to be the same due to the fact that the protrusions 14a are divided in a parallel fashion. The cross-sections of the protrusions 14a are roughly rectangular wave shaped, with the base side being slightly wider at the bottom due to die extraction during press working. The height of the protrusions 14a is substantially equal to the thickness of the frame 17. As a result, air flow paths of a predetermined open area which run in the vertical direction between the frames 17 on both sides in a stacked state are ensured.

The flat surface of a top portion 141 of each protrusion 14a serves as an abutting portion, i.e., a gas diffusion portion, which contacts the diffusion layer on the air electrode 12 side. Portions that extend in a direction intersecting with the surface of the gas diffusion electrode between protrusions 14a and the bottom portions that connects those portions together form spacer portions 142 which ensure the sectional area of the gas passage. The bottom portions serve as abutting portions which conduct electricity between the collector 14 and the separator substrate 16.

Hydrophilic treatment is performed on the air electrode side collector 14. This treatment method is one in which a hydrophilic agent is coated on the surface. Examples of the hydrophilic agent include polyacrylamide, polyurethane resin, and titanium oxide (1502). Other hydrophilic treatments include a treatment for roughening the metal surface. Plasma treatment is one such example of this. Hydrophilic treatment is preferably performed on the portions where the temperature becomes highest, such as the bottom portions 141 between protrusions 14a that contact the single cells 10A, particularly on the air flow path side. Performing this kind of hydrophilic treatment promotes wetting of the abutting surface between the collector 14 and the air electrode side diffusion layer, thereby improving the effect from the latent heat cooling by the water. Also, this makes it more difficult for water to clog at the open portions of the mesh, thereby making it even less likely that the water will interrupt the supply of air.

The fuel electrode side collector 15 is made of a rectangular mesh plate member (in the drawing, only a portion is shown as mesh in order to make it easier to see the shape of the plate surface) which has cancellate diamond-shaped air holes 153 of dimensions the same as those of the air electrode side collector 14. A plurality of protrusions 15a are extrusion formed by press working. The protrusions 15a are such that bottom portions 151 are flat and the cross-sectional shape is one of substantially rectangular waves, just like the protrusions 14a earlier. The protrusions 15a of this collector 15, however, travel the entire width, horizontally, of the plate surface at equal distances in the vertical direction.

The flat surface of the bottom portion 151 of each protrusion 15a serves as an abutting portion, i.e., a gas diffusion portion, which contacts the fuel electrode 13. The cross-sections of the protrusions 15a are also roughly rectangular wave shaped, with the base side being slightly wider at the bottom due to die extraction during press working. The height of the protrusions 15a, together with the thickness of the single cell 10A, essentially corresponds to the thickness of the frame 18. As a result, fuel flow paths of a predetermined open area which run horizontally through the inside of the frame 18 when they are stacked are ensured.

Both collectors 14 and 15 of the foregoing structure are arranged so as to sandwich the separator substrate 16 in between them with the bottom portions 141 and 151 both facing to the outside. At this time, the top portions 142 and 152 of the collectors 14 and 15 abut against the separator substrate 16, thereby enabling electricity to pass both ways. Also, by having the collectors 14 and 15 sandwich the separator substrate 16, air flow paths (the direction of flow is indicated by the arrows A in FIG. 10), which serve as both reaction gas supply passages and cooling spaces, are formed on one side of the separator substrate 16, while fuel flow paths (the direction of flow is similarly indicated by the arrows H in FIG. 10) are formed on the other side of the separator substrate 16. Air and water are then supplied to the air electrode 12 of the single cell 10A from the vertical air flow paths A, while hydrogen is similarly supplied to the fuel electrode 13 of the single cell 10A from the horizontal fuel flow paths H.

The frames 17 and 18 are each arranged on the outside of the separator 10B structured as described above. As shown in FIGS. 8 and 9, with the exception of the portion on the outer end (the upper-most portion in FIG. 8 and the left end in FIG. 9), the frame 17 which surrounds the collector 14 includes only vertical frame portions 171 that surround both sides along the short sides of the collector 14, and through which long holes 172 are provided in the direction of plate thickness in order to form fuel flow paths. The plate thickness of the frame 17 is comparable to the thickness of the wavy-shaped collector 14, as described above. Therefore, when the frame 17 and the collector 14 are together, the bottom portions 141 are in contact with the air electrode 12 of the single cell 10A, while the top portions 142 are in contact with the collector 15 via the separator substrate 16. The separator substrate 16 has outer dimensions that correspond to the height and entire width of the frame 17, and is provided with similar long holes 162 in positions that overlap with the long holes 172 in the frame 17. Thus, the air flow paths that are surrounded by the separator substrate 16 and the air electrode 12 surface of the single cell 10A and which pass vertically through the entire single cell unit are established between both vertical frame portions 171 of the frame 17.

The frame 18 that surrounds the collector 15 and the single cell 10A is the same size as the frame 17, but differs from the frame 17 in that it is a complete frame that includes both left and right vertical frame portions (although not shown in FIG. 8 due to the fact that they are farther to the right than the drawing shows, they are frame portions with the ends on both sides in the same positions as the left and right side ends of both vertical frame portions 171 of the frame 17, and a width in the horizontal direction substantially the same as that of top and bottom horizontal frame portions) and top and bottom horizontal frame portions 182. With the exception of the portion on the outer end (the lower-most portion in FIG. 5, i.e., the surface shown in FIG. 7), the frame 18 includes a thin backup plate 18a that extends parallel to the left and right vertical frame portions and overlaps with the left and right ends of the collector 15, and a thick backup plate 18b. The space surrounded by these backup plates 18a and the vertical frame portions forms the fuel flow path which is aligned with the long holes 172 that pass through the frame 17 in the direction of plate thickness.

The plate thickness of the frame 18 is comparable to the thickness of the wavy shaped collector 15, as described above. Therefore, when the frame 18 and the collector 15 are together, the protrusions 15a of the collector 15 are in contact with the fuel electrode: 13 of the single cell 10A, while the bottom portions are in contact with the collector 14 via the separator substrate 16. Thus, the fuel paths H are formed in the stacking direction aligned with the long holes 172 in the vertical frame portions 171 of the frame 17 between both vertical frame portions of the frame 18 and the backup plate 18a. Further, the fuel flow paths H which are horizontal flow paths sandwiched between the separator substrate 16 and the backup plate 18a are defined by the wavy shape of the collector 15 on the inside each frame 18.

The separator 10B is formed with the collectors 14 and 15 and the separator substrate 16 being retained by the frames 17 and 18 of the above described structures. A cell module is then formed by alternately stacking the separators 10B with the-single cells 10A. As shown in FIG. 2, slit-shaped air flow paths are thus formed, which travel through the entire cell module in the vertical direction, from the top surface of the cell module to the bottom surface of the cell module, in the portions that are sandwiched between the frames 18 in the stacked cell modules.

The fuel cell stack (see FIG. 1) which is formed by arranging a plurality of individual cell modules of the foregoing structure together in a case generates power by supplying air and water, which have mixed in the air manifold 22, from the top portion of the fuel cell stack 1 and hydrogen from the side. The air and water supplied to the air flow paths enter the top portion of the air flow paths in a state in which water droplets are mixed with the air flow in the form of mist (hereinafter, this state will be referred to as “mixed flow”). During steady operation of the fuel cell, the mixed flow within the air flow paths becomes heated due to the heat generated by the single cell 16A from the reaction. Some of the water droplets in the mixed flow adhere to the mesh of the collector 14. The water droplets that do not adhere to the mesh of the collector 14 are heated in the vapor phase between the collector 14 and the gas diffusion layer and evaporate, such that a latent heat cooling effect is produced which removes heat from the collector 14. This water which has become vapor retains humidity, thus suppressing evaporation of the moisture within the polymer electrolyte membrane 11 from the air electrode 12 side. The excess air, vapor, and water that have entered to air flow paths are then discharged from the openings of the air flow paths at the bottom of the cell stack.

On the other hand, the hydrogen is supplied to the fuel flow paths from the long holes in the vertical frame portions of the frame 18 on the outermost side shown in FIG. 7. It then flows into the spaces surrounded by the vertical and horizontal frame portions of each frame 18 and the backup plates 18a via the long holes 172 in the vertical frame portions 171 of the frame 17, and is supplied to the fuel electrode 13 side of the single cell 10A via the spaces sandwiched between the separator substrate 16 and the backup plate 18a. As a result, hydrogen is supplied to the fuel electrode 13 of the single cell 10A. Of the hydrogen that flows in the horizontal direction along the fuel electrode 13, the excess portion that did not contribute to the reaction is discharged to the hydrogen flow paths on the opposite side and recirculated by the pipe shown in FIG. 1 that is connected to the hydrogen flow path, and finally discharged to the combustor.

Thus, as described above, some of the water that is delivered together with the air to the fuel cell stack adheres to the mesh of the collector 14 and evaporates, while the rest evaporates without adhering to the mesh in the gas phase and removes latent heat, thus preventing the evaporation of moisture from the electrolyte membrane 11 on the air electrode 12 side. As a result, the electrolyte membrane 11 is constantly maintained in a uniformly moist state by the produced water without drying on the air electrode side 12. Also, the water supplied to the surface of the air electrode 12 removes heat from the air electrode 12 itself, thereby cooling it. As a result, the temperature of the fuel cell stack 1 can be controlled.

The flow of hydrogen within the fuel cell stack 1 is as described above. In the fuel supply system 4, the concentration of the hydrogen gas discharged from the hydrogen passage of the fuel cell stack 1 by the suction of the pump 47 is measured by the concentration sensors 45A and 45B. When the measured concentration is equal to, or greater than, a predetermined concentration, the hydrogen gas is recirculated to the hydrogen supply line 40 via the recirculation check valve 48 by closing the electromagnetic valve 52. When the measured concentration is less than the predetermined concentration, on the other hand, the hydrogen is discharged to the combustor 53 via the check valve 51 and the electromagnetic valve 52 by intermittently opening the discharge electromagnetic valve 52, such that exhaust which has been completely combusted by the combustor 53 is released to the outside air.

With this system, the fuel cell stack 1 can be sufficiently wet and cooled by supplying water to the fuel cell stack 1 in the air flow, even without providing a cooling system. At this time, the temperature of the fuel cell stack 1 can be maintained at the desired temperature by controlling the amount of water injected from the nozzles 63 into the air manifold 22. This can be done by suitably controlling the output and operating intervals of the pump 62 depending on the temperature of the exhausted air detected by the exhaust temperature sensor 32.

More specifically, the evaporation amount increases when the amount of water supplied to the fuel cell stack 1 is increased, and decreases when the amount of water supplied to the fuel cell stack 1 is decreased. Similarly, the temperature decreases when the airflow is increased, and increases when the airflow is decreased. Therefore, the operating temperature can be controlled by controlling the amount of water and airflow supplied. Water that is discharged together with air from the fuel cell stack 1 is discharged with most of it being in a liquid state. Therefore, that water flows to the water return line 60a, is drawn up by the pump 65 and returned to the water tank 61 via the check valve 66. The water that has evaporated and is therefore in the form of vapor, or water that is not recovered to the water return line 60a is condensed by the water condenser 31 so that it is liquefied, and then drawn up by the pump 65 and returned to the water tank 61. Some of the water vapor in the exhausted air is thought to come from the reaction water following a power generating reaction of the fuel cell stack 1. The water level in the water tank 61 is monitored by the water level sensor 64.

This fuel cell system has several characteristics. First, the collector 14 that abuts directly against the air electrode 12 of the single cell 10A is a porous wire mesh. As a result, the supply of air to the air electrode 12 is no longer restricted due to the overlapping of the hole portions, as it is in the related art described in the beginning of this specification. Further, the contact surface of the supplied air and the collector 14 is increased due to the formation of the holes and the curve of the rectangular wave-shaped plate, which improves the function as radiation fins of transferring heat generated by the air electrode 12 at the collector 14 to the air flowing through the cooling spaces. Therefore, both the diffusivity of air and the cooling efficiency can be improved by a simple structure in a fuel cell in which the single cells 10A are cooled using air supplied to the air electrode side.

Furthermore, the collector 14 is formed of a fine mesh with openings also formed in the contact surface that is in contact with the electrode diffusion layer. Therefore, the mixed flow of air and water is mixed upon passing through these openings, and the mixed gas is also supplied to the contact surface of the electrode diffusion layer that is in contact with the collector 14. As a result, air can be evenly supplied to the entire surface of the electrode in the fuel cell stack 1, thereby enabling the concentration polarization to be reduced. Also, mesh contact between the electrode and the collector enables power to be evenly collected from the entire electrode, so power collection resistance decreases. Furthermore, the catalyst of the entire electrode can be used effectively so activation polarization is reduced. Also, the effective area of the electrode is also able to be increased, which is also advantageous.

In the first exemplary embodiment described above, the sides of the separator that contact the electrode diffusion layers, i.e., the collectors 14 and 15, are made of expanded metal, but they are not limited to this. For example, other materials including, but not limited to, metal fiber, metal porous bodies, two-dimensional metal woven fabric, metal non-woven fabric, wavy metal bodies, grooved metal bodies, wire mesh, and punched metal may be used for the collectors 14 and 15. Another exemplary embodiment in which the collector material has been changed will now be described.

### Second Embodiment

A second exemplary embodiment shown next in FIG. 11 is an example in which the collectors 14 and 15 are made of punched metal. Furthermore, in this example, the wave dimensions, i.e., wave height and pitch, are the same as those of the collector on the fuel electrode side in the first exemplary embodiment in order to be able to use the same collector material. When this structure is employed, protrusions 16a that protrude toward the collector 14 side are also formed on the separator substrate 16 at a pitch that matches the pitch at which the top portions 142 of the collector 14 are arranged, such that the separator substrate 16 is also a wavy plate shape, in order to ensure the flow path sectional area on the air electrode side where the wave height is lower. Hereinafter, portions in this exemplary embodiment that are the same as those in the first exemplary embodiment will be denoted by the same reference numerals, and descriptions of those portions will be omitted. Only those parts that differ from the first exemplary embodiment will be described here.

In this example, the multiple holes formed by punching are formed on one side in material of the same thickness as the collectors 14 and 15 in the first exemplary embodiment. Consequently, in the example shown in the drawing, holes of 0.1 mm in height and width are formed 0.1 mm apart in a plate 0.2 mm thick. In the drawing, the openings of the holes 143 and 153 are parallel both vertically and horizontally, though they are not particularly limited to this. To the contrary, they may be aligned in any direction, including obliquely as they are in the first exemplary embodiment. The height of the protrusions 16a of the separator substrate 16 in this exemplary embodiment is set such that the sum of the height of the protrusions 16a and the height of the protrusions 14a of the collector 14 equals the height of the protrusions of the collector 14 in the first exemplary embodiment. As a result, the sectional area of the flow path on the air electrode side can be the same as it is in the first exemplary embodiment.

In the second exemplary embodiment as well, the collector 14 that contacts the diffusion layer is a wavy plate of fine mesh, just as in the first exemplary embodiment, which enables effects similar to those obtained with the first exemplary embodiment to be obtained with the second exemplary embodiment.

### Third Embodiment

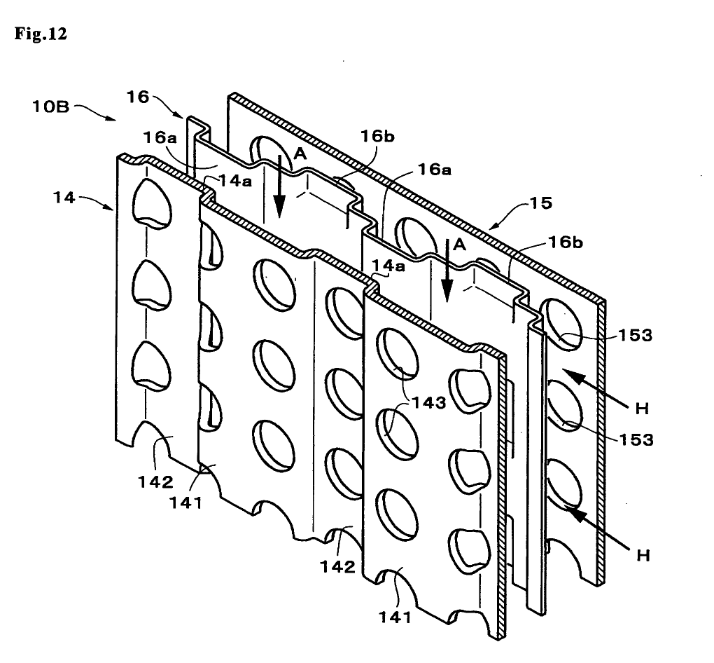

The example shown next in FIG. 12 is one in which both of the collectors 14 and 15 are made of punched metal, just as in the second exemplary embodiment, but the collector 15 on the fuel electrode side is formed of a flat, non-wavy plate. With this example, the separator substrate 16 is formed of a wavy plate that has protrusions 16a and 16b that protrude toward both the air electrode side and the fuel electrode side with respect to a reference plane of the substrate in order to ensure the sectional area of the flow paths on both the air electrode side and the fuel electrode side. All other structure is the same as that in the second exemplary embodiment, with like portions denoted by like reference numerals. Descriptions thereof would be redundant and so will be omitted here.

### Fourth Embodiment

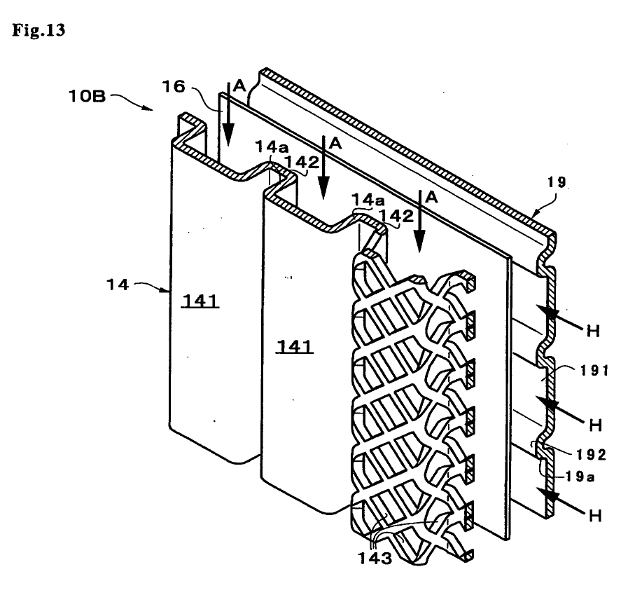

Instead of using the air electrode side collector 14 which serves as a radiator plate that abuts against the air electrode 12 and is made of an expanded metal with many openings formed in it just like the first exemplary embodiment, the example shown next in FIG. 13 is one that uses a fuel electrode side collector 19 which serves as a radiator plate that abuts against the fuel electrode 13 and is made of a plate member with no openings in it. The fuel electrode side collector 19 is formed of a rectangular metal plate of the same dimensions as the air electrode side collector 14 but with no openings in it. A plurality of protrusions 19a are extrusion formed by press working. The protrusions 19a are such that bottom portions 191 are flat and the cross-sectional shape is one of substantially rectangular waves, just like the protrusions 14a earlier. The protrusions 19a of this collector 19, however, travel the entire width, horizontally, of the plate surface at equal distances in the vertical direction. The flat surfaces of the bottom portions 191 between the protrusions 19a serve as abutting portions which contact the fuel electrode 13, and top portions 192 of the protrusions 19a serve as abutting portions which contact the separator substrate 16. The cross-sections of the protrusions 19a are roughly rectangular wave shaped, with the base side being slightly wider at the bottom due to die extraction during press working. The height of the protrusions 19a, together with the thickness of the single cell 10A, essentially corresponds to the thickness of the frame 18. As a result, fuel flow paths of a predetermined open area which run horizontally through the inside of the frame 18 when they are stacked are ensured.

In this exemplary embodiment, the fuel electrode side collector 19 is used which serves as a radiator plate that abuts against the fuel electrode 13 and is formed of a metal plate with no openings in it. As a result, heat transfer performance is improved so the cooling effect is increased compared to when the fuel electrode side collector 15 which is made of an expanded metal, as in the first exemplary embodiment, is used.

Also, drying of the single cell 10A can be suppressed because openings are not formed in the bottom portion 191 which serves as an abutting portion that contacts the fuel electrode 13. From the viewpoint of suppressing drying of the single cell 10A, it is sufficient that openings not be formed in at least the bottom portions 191, though openings may be formed in other portions of the fuel electrode side collector 19, for example, in portions such as the protrusions 19a.

Furthermore, the fuel electrode side collector 19 that serves as a radiator plate that abuts against the fuel electrode 13, which does not have openings formed in it can be used in a portion of the fuel cell stack 1 that tends to become dry, and the air electrode side collector 14 which does have openings formed in it can be used in a portion of the fuel cell stack 1 that does not tend to become dry.

All other structure is the same as that in the first through the third exemplary embodiments, with like portions denoted by like reference numerals. Descriptions thereof would be redundant and so will be omitted here.

1. A separator of a fuel cell system, which is inserted between single cells, each single cell having an electrolyte sandwiched between electrodes, in order to form a cooling space between the single cells, the separator comprising:
a porous radiator plate that abuts against one of the electrodes of one of the single cells.

2. The separator according to claim 1, wherein the radiator plate includes a heat transfer portion that contacts the electrode and a heat radiation portion which extends out into a space from the heat transfer portion, the heat transfer portion and the heat radiation portion being integrally provided.

3. The separator according to claim 2, wherein the heat radiation portion is such that the cooling space is divided into multiple spaces which extend from one end of the cooling space to the other end of the cooling space.

4. The separator according to claim 2, wherein the radiator plate is formed of a wire mesh member having the shape of a wavy plate with rectangular waves, and wave bottom portions of the rectangular waves serve as the heat transfer portion that contacts the electrode.

5. The separator according to claim 4, wherein the aperture ratio of the wire mesh member is at least 25%.

6. The separator according to claim 4, wherein the hole diameter of the wire mesh member is at most 1 mm.

7. The separator according to claim 1, wherein the electrolyte of each single cell contains water.

8. A fuel cell system in which a separator is interposed between fuel cells, each fuel cell having an electrolyte sandwiched between electrodes, in order to form a cooling space through which air flows at normal pressure between the single cells, wherein the separator includes a porous radiator plate that abuts against one of the electrodes of one of the single cells.

9. The fuel cell system according to claim 8, wherein the radiator plate includes a heat transfer portion that contacts the electrode and a heat radiation portion which extends out into a space from the heat transfer portion, the heat transfer portion and the heat radiation portion being integrally provided.

10. The fuel cell system according to claim 9, wherein the heat radiation portion is such that the cooling space is divided into multiple air-flowing spaces which extend from one end of the cooling space to the other end of the cooling space.

11. The fuel cell system according to claim 9, wherein the radiator plate is formed of a wire mesh member having the shape of a wavy plate with rectangular waves, and wave bottom portions of the rectangular waves serve as the heat transfer portion that contacts the electrode.

12. The fuel cell system according to claim 11, wherein the aperture ratio of the wire mesh member is at least 25%.

13. The fuel cell system according to claim 11, wherein the hole diameter of the wire mesh member is at most 1 mm.

14. The fuel cell system according to claim 8, wherein the electrolyte of each single cell contains water.

15. The separator according to claim 3, wherein the radiator plate is formed of a wire mesh member having the shape of a wavy plate with rectangular waves, and wave bottom portions of the rectangular waves serve as the heat transfer portion that contacts the electrode.

16. The fuel cell system according to claim 10, wherein the radiator plate is formed of a wire mesh member having the shape of a wavy plate with rectangular waves, and wave bottom portions of the rectangular waves serve as the heat transfer portion that contacts the electrode.
